(19) United States
(12) Patent Application Publication
(10) Pub. No.: US 2008/0106693 A1
(43) Pub. Date: May 8, 2008

(54) Eyeglasses having function of broadcasting music

(76) Inventor: Ching-Hsiang Wang, Tainan City (TW)

Correspondence Address: Ching-Hsiang Wang, P.O. Box 90, Tainan City, 70499, omitted

(21) Appl. No.: 11/592,988

(22) Filed: Nov. 6, 2006

(51) Int. Cl. G02C 11/00

(52) U.S. Cl. 351/158

(57) ABSTRACT

Eyeglasses having function of broadcasting music includes a pair of eyeglasses with two temples and a music broadcaster clamped on the temple of the eyeglasses. The music broadcaster is composed of a positioning member, a basic body and an earphone. The positioning member to be clamped on the temple has its lower side formed with a clamping portion and one outer side provided with an engage groove. The basic body has one sidewall secured with an engage block to be engaged and positioned in the engage groove of the positioning member, and has its rear end bored with an earphone hole for receiving the earphone therein. Thus, the eyeglasses wearer can listen to the music broadcast by the music broadcaster that can quickly be assembled on or disassembled from any kind of eyeglasses by means of the positioning member.

### BACKGROUND OF THE INVENTION

1. Field of the Invention

This invention relates to a pair of eyeglasses having function of broadcasting music, particularly to one provided with a music broadcaster able to be quickly assembled on or disassembled from the temple of the eyeglasses by means of a positioning member; therefore, the eyeglasses wearer can at the same time listen to the music broadcast by the music broadcaster.

2. Description of the Prior Art

Generally, conventional eyeglasses made of a frame and two temples pivotally assembled at the opposite sides of the frame are mainly employed for reading or watching things clearly, or for protecting eyes from being hurt by strong sunlight. Nowadays, people always require novelty and diversification in recreational products or the like; therefore, Walkmans, for instance, have been continuously improved and modified for meeting consumers' needs. A portable music broadcaster (like MP3) most popular for the present is to have an earphone line connected with the broadcaster MP3 for facilitating a user to listen to music, broadcasting or recording tapes. Although such a portable broadcaster is convenient to be carried about, yet comparatively long earphone connecting lines are needed for connecting the basic body of broadcaster, so that when the earphones are used, the basic body of the broadcaster can be deposited in a user's pocket or hung in front of a user's chest. However, these long earphone connecting lines are easy to get entangled and damaged in case of pulling and dragging improperly, and the basic body of the broadcaster, either put in user's pocket or hung in front of a user's chest, is likely to be collided and get damaged.

### SUMMARY OF THE INVENTION

The objective of the invention is to offer a pair of eyeglasses having function of broadcasting music, provided with a music broadcaster able to be quickly assembled on or disassembled from the temple of the eyeglasses by means of a positioning member, enabling the eyeglasses wearer to listen to the music broadcast by the music broadcaster at the same time.

The eyeglasses having function of broadcasting music in the present invention includes a pair of eyeglasses with two temples and a music broadcaster clamped on the temple of the eyeglasses. The music broadcaster is composed of a positioning member, a basic body and an earphone. The positioning member to be clamped on the temple has its lower side formed with a clamping portion and one sidewall provided with an engage groove. The basic body of the music broadcaster has one side wall fixed with an engage block to be engaged and positioned in the engage groove of the positioning member and has its rear end bored with an earphone hole for the earphone to be inserted therein.

### BRIEF DESCRIPTION OF DRAWINGS

This invention will be better understood by referring to the accompanying drawings, wherein:

FIG. 1 is an exploded perspective view of eyeglasses having function of broadcasting music in the present invention;

FIG. 2 is an exploded perspective view of a music broadcaster to be assembled on the eyeglasses in the present invention;

FIG. 3 is a perspective view of the eyeglasses having function of transmitting music in the present invention; and

FIG. 4 is a perspective view of the eyeglasses having function of broadcasting music in a using condition in the present invention.

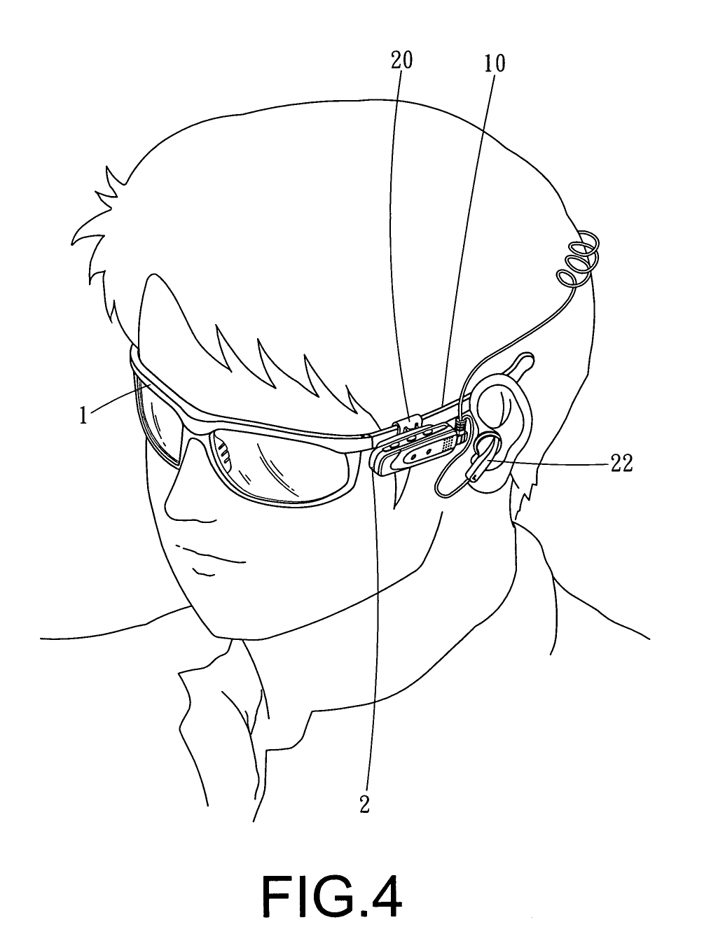

### DETAILED DESCRIPTION OF THE PREFERRED EMBODIMENT

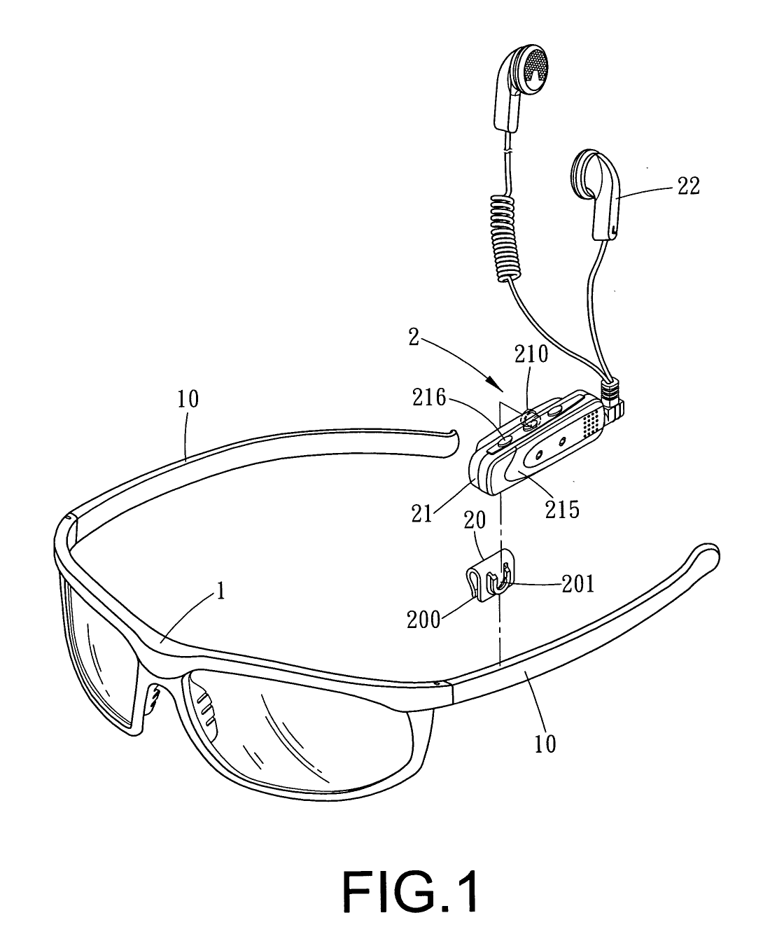

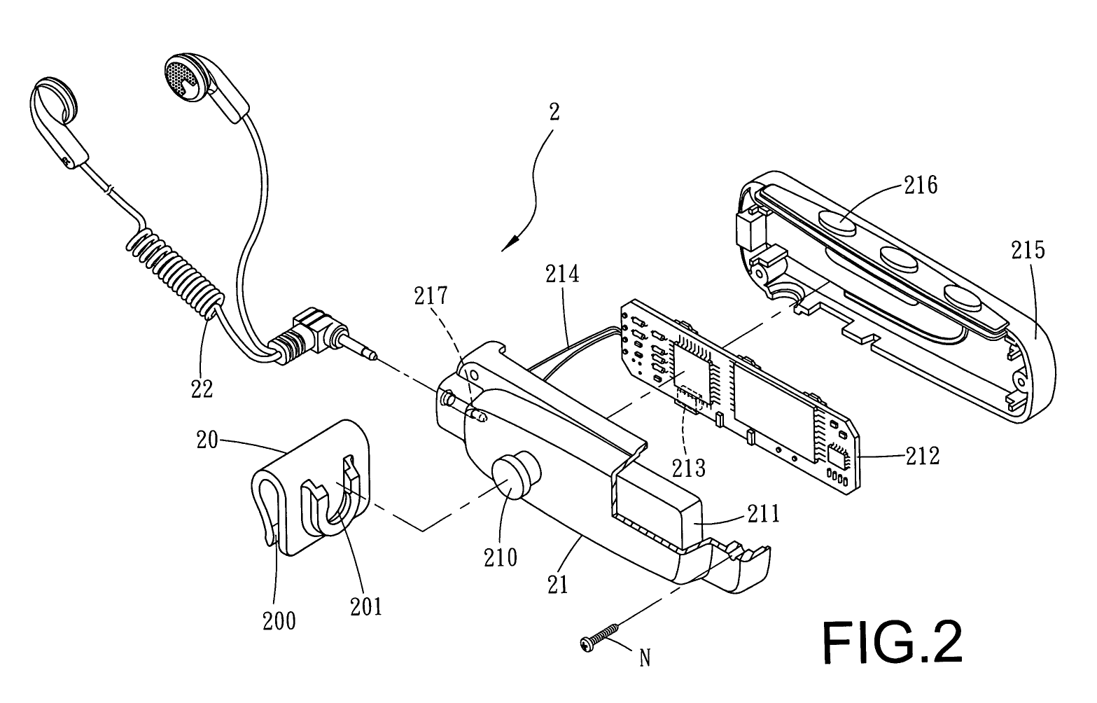

A preferred embodiment of eyeglasses having function of broadcasting music in the present invention, as shown in FIGS. 1 and 2, includes a pair of eyeglasses 1 and a music broadcaster 2 combined together.

The eyeglasses 1 have two temples 10 respectively and pivotally assembled at the opposite sides.

The music broadcaster 2 to be clamped on the temple 10 of the eyeglasses 1 is composed of a positioning member 20, a basic body 21 and an earphone 22. The positioning member 20 to be clamped on the temple 10 of the eyeglasses 1 has its lower side formed with a clamping portion 200 and one outer side provided with an engage groove 201. The basic body 21 of the music broadcaster 2 has one sidewall fixed with an engage block 210 to be engaged with the engage groove 201 of the positioning member 20. The basic body 21 is disposed with cells 211 and a circuit board 212 in the interior, and the circuit board 212 has its lower end bored with insert holes 213 for USB connection lines to be inserted therein for broadcasting music and its outer end connected with electric wires 214. A shell 215 having a plurality of press buttons 216 disposed thereon is threadably mounted on the outer side of the basic body 21 of the music broadcaster 2 by bolts (N). Further, the basic body 21 of the music broadcaster 2 has its rear end bored with an earphone hole 217 for the earphone 22 to be inserted therein.

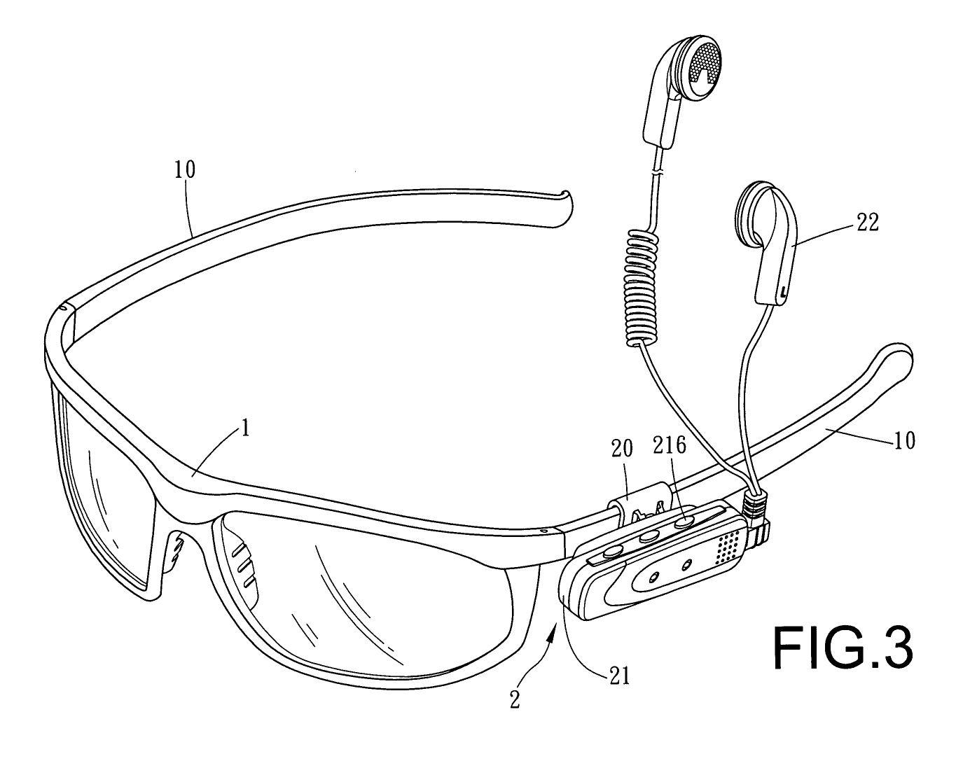

In assembling and using, as shown in FIGS. 1, 2 and 3, firstly, the engage block 210 at one side of the basic body 21 of the music broadcaster 2 is engaged and positioned in the engage groove 201 of the positioning member 20 and then the positioning member 20 is clamped on the temple 10 of the eyeglasses 1. Next, the earphone 22 is inserted in the earphone hole 217 at the rear end of the basic body 21. Thus, by pressing the press buttons 216 on the shell 215, the music broadcaster 2 can be started to broadcast music and the eyeglasses 1 wearer can listen to the music through the earphone 22. By so designing, a person wearing such eyeglasses 1 can at the same time listen to the music broadcast by the music broadcaster 2.

When the eyeglasses 1 wearer does not want to listen to the music broadcast by the music broadcaster 2, the music broadcaster 2 can easily be removed from the temple 10 of the eyeglasses 1. Being assembled on the eyeglasses 1 by clamping the positioning member 20 on the temple 10, the music broadcaster 2 of this invention can quickly be assembled on or disassembled from any kind of eyeglasses, convenient in use and original in design.

While the preferred embodiment of the invention has been described above, it sill be recognized and understood that various modifications may be made therein and the appended claims are intended to cover all such modifications that may fall within the spirit and scope of the invention.

What is claimed is:

1. Eyeglasses having function of broadcasting music comprising a pair of eyeglasses with two temples and a music broadcaster, said music broadcaster clamped on said temple of said eyeglasses, said music broadcaster composed of a positioning member, a basic body and an earphone, said positioning member having its lower side formed with a clamping portion, said clamping portion of said positioning member clamped on said temple of said eyeglasses, said positioning member having one outer side provided with an engage groove, said basic body of said music broadcaster having one side wall secured with an engage block, said engage block engaged and positioned in said engage groove of said positioning member, said basic body of said music broadcaster having its rear end bored with an earphone hole for said earphone to be inserted therein; and
said eyeglasses of this invention able to broadcast music through said music broadcaster clamped on said temple, said music broadcaster able to be quickly assembled on or disassembled from any kind of eyeglasses by means of said positioning member.

2. The eyeglasses having function of broadcasting music as claimed in claim 1, wherein said basic body of said music broadcaster is disposed with a cell and a circuit board in the interior, said circuit board having its lower end bored with insert holes and its outer end connected with electric wires, said basic body of said music broadcaster having its outer side threadably mounted thereon with a shell, said shell provided thereon with a plurality of press buttons.
